(19) United States
(12) Patent Application Publication
(10) Pub. No.: US 2005/0102934 A1
(43) Pub. Date: May 19, 2005

(54) Window that generates solar-power electricity

(76) Inventor: Tyson Y. Winarski, Tempe, AZ (US)

Correspondence Address: STEPTOE & JOHNSON LLP, 201 EAST WASHINGTON STREET, SUITE 1600, PHOENIX, AZ, 85004, US

(21) Appl. No.: 10/712,219

(22) Filed: Nov. 13, 2003

(51) Int. Cl. E06B 9/01

(52) U.S. Cl. 52/204.6

(57) ABSTRACT

A double-pane window, installed at a known azimuth, houses a plurality of solar cells. During available daylight, the solar cells track the apparent motion of the sun to provide electricity, based on the 24-hour time and the known azimuth of the window. When sunlight is not available due to either nighttime or the azimuth of the window, the solar cells are parked. This parked position preferably provides a view to the occupants of the building using these double-pane windows. Alternately, the parked position can block incoming viewing, and thus provide a measure of privacy.

### FIELD OF THE INVENTION

The present invention relates to the field of solar generated electricity.

### BACKGROUND OF THE INVENTION

The traditional uses of panels of solar cells have not realized their full potential because the electricity produced by these panels of solar cells is more expensive than that generated by the consumption of fossil fuels.

Glass panes are a very common exterior feature of high-rise office and apartment buildings. Sometimes these high-rise buildings are called skyscrapers. Glass panes afford views for the workers and occupants in the high-rise buildings. Additionally, glass panes permit sunlight to enter the building, to illuminate its interior.

Via pivot shafts, gears, and pinions, this invention uses solar cells between the glass panes of double-pane windows to produce solar generated electricity while generally allowing a portion of the views afforded by glass panes themselves. These electricity-producing double-pane windows could be used in any structure, such as a home or trailer, as well as a high-rise building. However, these electricity-producing double-pane windows are particularly advantageous to high-rise buildings where there is so much glass in use.

### SUMMARY OF THE INVENTION

The object of the present invention is to provide a sealed double-pane window that also serves as a power source because the double-pane window houses a plurality of solar cells. More specifically, this invention uses pivot shafts to direct narrow strips of solar cells to track the apparent motion of the sun. When the sun has past the window, or before the sun has approached the window, the solar cells are placed in a parked position which is preferably perpendicular to the glass, to maximize the view afforded to the office worker. Thus, the viewer merely sees the thin dimension of each solar cell when electricity cannot be generated.

Further objects and advantages of the invention will become apparent as the following description proceeds and the features of novelty which characterize this invention are pointed out with particularity in the claims annexed to and forming a part of this specification.

### BRIEF DESCRIPTION OF THE DRAWINGS

The novel features that are considered characteristic of the invention are set forth with particularity in the appended claims. The invention itself; however, both as to its structure and operation together with the additional objects and advantages thereof are best understood through the following description of the preferred embodiment of the present invention when read in conjunction with the accompanying drawings wherein:

FIG. 1 shows a top view of a cross-section of a double-pane window with parallel strips of solar cells;

FIG. 2 shows a frontal view of a cross-section of a double-pane window with parallel strips of solar cells;

FIG. 3 shows the spectral response versus photon energy for a typical solar cell and a violet-responsive solar cell;

FIG. 4 shows the transmissivity versus wavelength for a dichronic mirror;

FIG. 5 shows an electrical assembly for a double-pane window with solar cells connected in series to increase voltage and in parallel to increase current;

FIG. 6 shows a top view of an illumination sensor using a shade between parallel photocells;

FIG. 7 shows a top view of an illumination sensor with angled photocells;

FIG. 8 shows a motion control algorithm for the parallel strips of solar cells;

FIG. 9 shows a semiconductor chip; and

FIG. 10 shows a binary arithmetic calculator for calculating the tracking angle of the solar cells.

### DESCRIPTION OF THE PREFERRED EMBODIMENTS

While the invention has been shown and described with reference to a particular embodiment thereof, it will be understood to those skilled in the art, that various changes so in form and details may be made therein without departing from the spirit and scope of the invention.

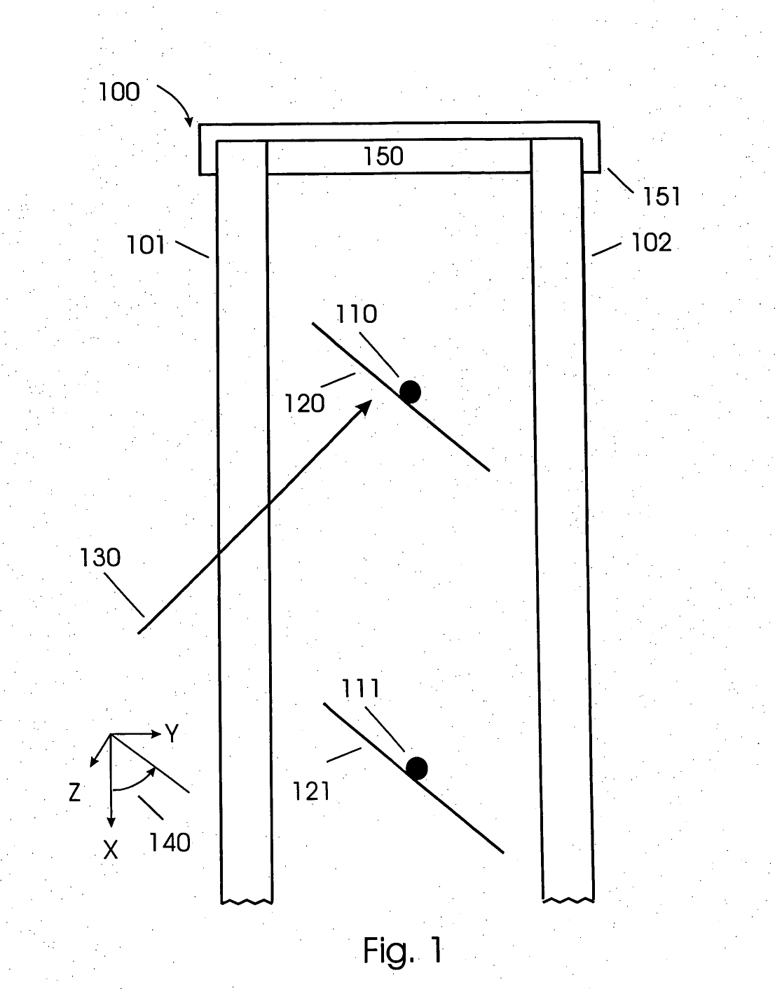

FIG. 1 shows a top view of a cross-section of a double-pane window 100 which has exterior pane 101 and interior pane 102. Double-pane window 100 could equally be called a dual-pane window. Exterior pane 101 and interior pane 102 are preferably flat panes and preferably made of glass. However, exterior pane 101 and interior pane 102 could be comprised of other materials, such as polycarbonate or acrylic. Exterior pane 101 and interior pane 102 are each parallel to the X-Z vertical plane shown-in FIG. 1. The X and Y axes in FIG. 1 are in the horizontal plane, with the Y axis pointing from exterior pane 101 towards interior pane 102 of double-pane window 100. In FIG. 1, the Z axis is preferably pointing in the vertically-upwards direction.

Double-pane window 100 is preferably sealed against contaminants such as dust, dirt, and debris by seal 151 which runs along the outer perimeter of double-pane window 100. In conjunction with seal 151, spacer 150 also runs along the outer perimeter of double-pane window 100 to keep exterior pane 101 and interior pane 102 uniformly spaced. Seal 151 and spacer 150 preferably have the same thermal coefficient of expansion so that during diurnal and seasonal temperature changes, the seal is maintained. A typical material for seal 151 and spacer 150 is aluminum or an aluminum alloy. A thin elastomeric coating on seal 151 and spacer 150, such as polytetrafluoroethylene, may be used to augment the sealing.

In between exterior pane 101 and interior pane 102 are a plurality of solar cells. In FIG. 1, solar cells 120 and 121 are shown. Solar cell 120 rotates about the Z axis by being fixedly attached to rotating pivot shaft 110. Similarly, solar cell 121 rotates about the Z axis by being fixedly attached to rotating pivot shaft 111. Both solar cells 120 and 121 make the same angle 140 about the Z axis to receive sunlight 130, meaning that the plurality of solar cells rotate in unison in double pane window 100. Angle 140 is measured from the positive X axis. Angle 140 has a positive value when counterclockwise of the positive X axis, and a negative value when measured clockwise of the positive X axis, as shown in FIG. 1.

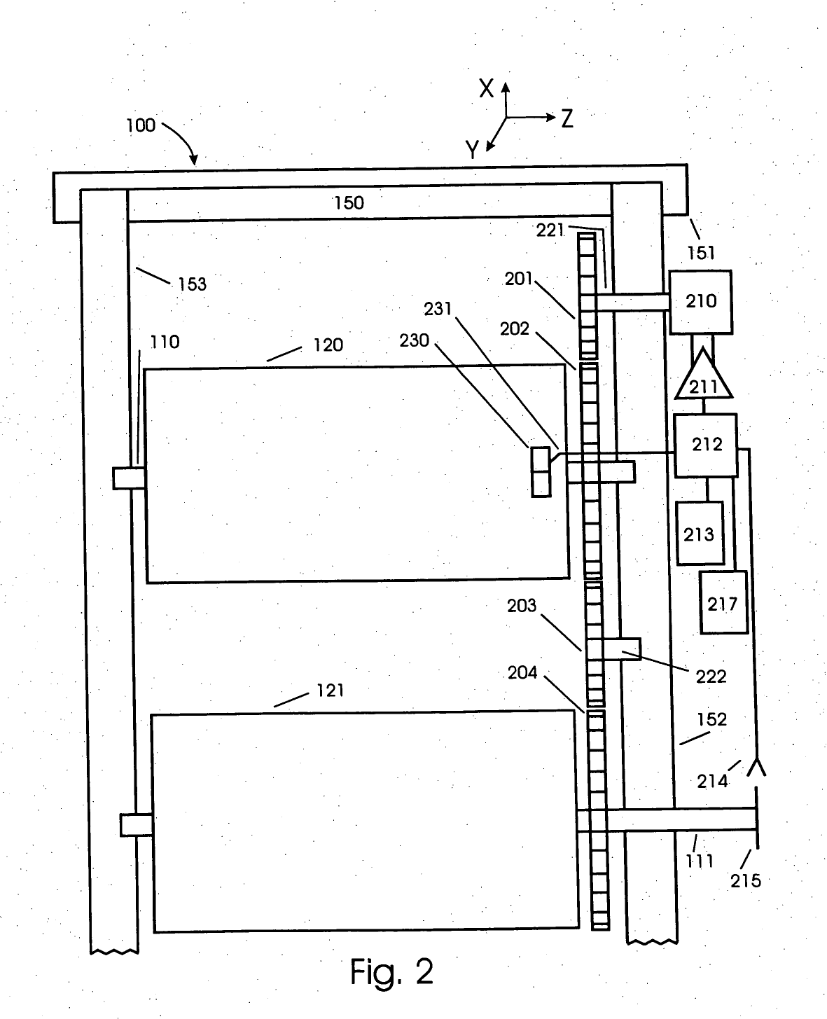

Frontal view FIG. 2 shows additional structure of double-pane window 100. Pivot shafts 110 and 111 extend between spacers 152 and 153. Spacers 152 and 153 serve the same function as spacer 150 of FIG. 1, which is to keep exterior pane 101 and interior pane 102 uniformly spaced.

Fixedly attached to pivot shaft 110 is gear 202, and fixedly attached to pivot shaft 111 is gear 204. Intermediate to gear 202 and gear 204 is pinion 203. Pinion 203 rotates about shaft 222, which is affixed to spacer 152. Drive gear 201 is turned by drive shaft 221, and drive shaft 221 is turned by motor 210. Motor 210, drive shaft 221, drive gear 201, gear 202, pinion 203, and gear 204 comprise a power train for rotating solar cells 120 and 121 in FIG. 2. Drive gear 201, gear 202, pinion 203, and gear 204 all have the same gear tooth systems, so that the teeth of adjacent gears mesh. The same gear tooth systems means that the gear teeth have the same pressure angle, same diametral pitch (ratio of the number of gear teeth and the pitch diameter of the gear), and overall similar general shape, otherwise the teeth of adjacent gears would not mesh and the power train would not operate. Drive gear 201, gear 202, pinion 203, and gear 204 are preferably spur gears, but could alternately be helical gears. Due to the light loading to rotate solar cells 120 and 121, drive gear 201, gear 202, pinion 203, and gear 204 are preferably made of the polymer called DELRIN. However, drive gear 201, gear 202, pinion 203, and gear 204 could also be made of other polymers such as NYLON or metals such as bronze, aluminum, titanium, or steel. Drive gear 201 is preferably fixedly held in place on drive shaft 221 via a-set screw which is screwed against a flat on drive shaft 221. Similarly, gears 202 and 204 are fixedly held in place via set screws which are screwed against flats on pivot shafts 110 and 111, respectively. Pinion 203 preferably rotates freely about static shaft 222. Alternately, shaft 222 may freely rotate and pinion 203 is held in place on shaft 222 via a set screw which is screwed against a flat on shaft 222.

Gears 202 and 204 have the same gear pitch-diameter. Pinion 203 need not have the same pitch-diameter as gears 202 and 204; however, should additional pinions be placed between additional gears in support of additional solar cells, all pinions will have the same pinion pitch-diameter and all gears will have the same gear pitch-diameter, in order that all solar cells track the sun in parallel. If N gears are used in double-pane window 100, then N−1 pinions are required. Drive gear 201 may have a smaller pitch diameter than gears 202 and 204, in order to provide more leverage for turning solar cells 120 and 121, thus allowing a smaller motor 210 to be used. Motor 210 could rotate pivot shaft 111 directly, without the use of drive gear 201, but this would require a larger motor than if drive gear 201 is employed and drive gear 201 has a smaller pitch diameter than gears 202 and 204.

Motor 210 is controlled by microprocessor 212. Motor 210 is preferably a stepper motor. However, motor 210 could also be a gear motor. Microprocessor 212 sends instructions to motor 210 via motion control amplifier 211, which amplifies the low level signals from the microprocessor into the current and voltage to rotate motor 210.

Microprocessor 212 preferably receives the rotational position of a pivot shaft via position sensor 215 and position sensor monitor 214. Position sensor 215 is preferably a digital encoder, and position sensor monitor 214 is preferably a digital encoder sensor. However, position sensor 215 could alternately be a rotary potentiometer and position sensor monitor 214 an analog to digital converter. In FIG. 2, position sensor 215 is fixedly mounted on pivot shaft 111; however, position sensor 215 could equally be fixedly mounted on pivot shaft 110. This way, microprocessor 212 can controllable rotate solar cells 120 and 121 up to ±90 degrees. Solar cells 120 and 121 are not rotated more than this, so that the electrical wiring in double-pane window 100 is not multiply twisted and eventually broken. Solar cells 120 and 121 are not rotated more than ±90 degrees, where zero degrees means that the solar cells are parallel to the X-Y plane and are parallel to exterior pane 101 and interior pane 102, and +90 or −90 degrees means that the solar cells are perpendicular to the X-Y plane and thus are perpendicular to exterior pane 101 and interior pane 102.

Microprocessor 212 also receives illumination input from position sensor 230 via wire 231. Illumination sensor 230 provides feedback to microprocessor 212 as to whether solar cells 120 and 121 are best aligned with the incoming solar radiation. If the solar cells are not best aligned with the incoming solar radiation, microprocessor 212 can cause the solar cells to be rotated clockwise or counterclockwise until such best alignment is obtained.

Microprocessor 212 can also read from memory 213. Memory 213 has information, such as the daily time of sunup and sundown in 24-hour time, and the number 15 which is used to compensate for the apparent motion of the sun. Our sun appears to move 360 degrees in 24 hours, which translates into 15 degrees per hour (360 degrees divided by 24 hours). Thus, microprocessor 212 needs to rotate solar cells 120 and 121 an average of 15 degrees per hour, during daylight hours. The time is provided to microprocessor is provided by 24-hour clock 217. Clock 217 gives time in hours and the decimal fraction thereof. For example, if the time is 1:15 pm, clock 217 would give the time as 13.25 hours. Memory 213 also has information regarding sunup and sundown during the year, in 24-hour time, so that solar cells 120 and 121 can remain perpendicular to exterior pane 101 and interior pane 102, thus allowing viewing out the window when the production of electricity is not possible.

Memory 213 also has the azimuth of the direction which double-pane window 100 is facing. For example, if double-pane window is facing due south, the value of the azimuth stored in memory 213 is 180 degrees.

Memory 213 is preferably a semiconductor chip. Memory 213 may be a PROM (programmable read only memory), EPROM (erasable, programmable read only memory), EEPROM (electrically erasable, programmable read only memory), or RAM (random access memory).

Thus, double-pane window 100 is capable of generating electricity while generally allowing light to enter a building. It is only during the period when solar cells 120 and 121 are parallel to exterior pane 101 and interior pane 102, that viewing would be most encumbered. At other times, values of Angle_140 other than zero allows light to illuminate the interior of the building and permits the occupant of that building to look outside, while solar-generated electricity is produced via light 130.

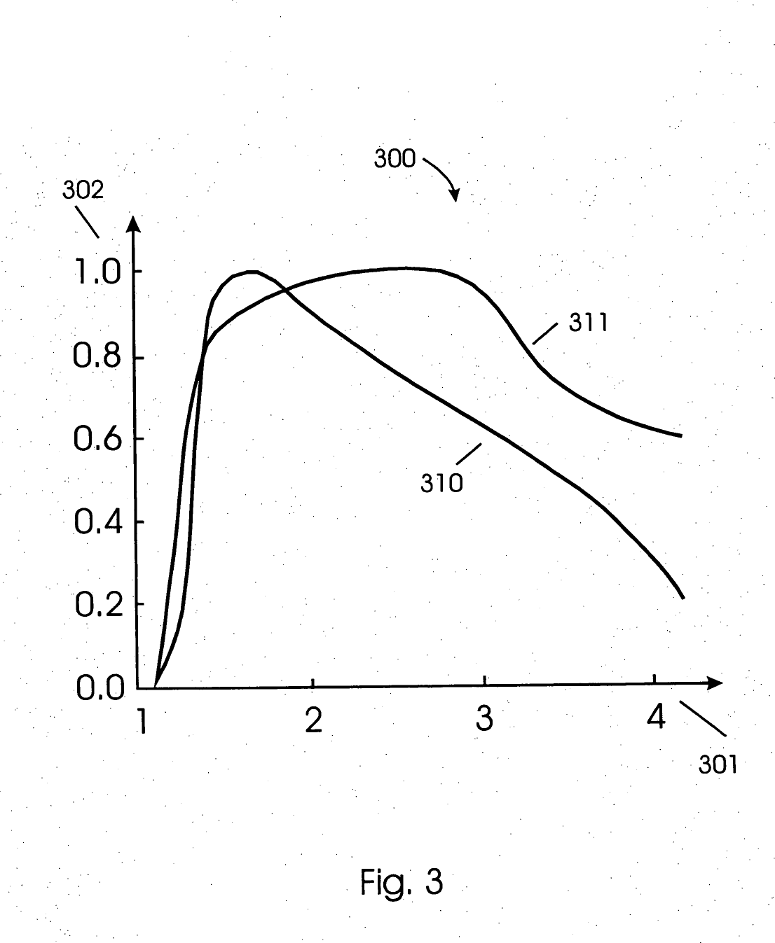

The electricity generating surfaces of solar cells 120 and 121 can have special spectral-response properties, as depicted in FIG. 3. FIG. 3 shows plots of spectral-response 302 versus photon energy in electron volts 301 for a typical n-p Silicon solar cell 310 and a violet-responsive solar cell 311. The active surface of typical solar cell 310 in FIG. 3, has a depth of 0.4 micrometers and a surface doping of 5*10E19 per cubic centimeter. The notation 10E19 represents 10 to the 19^{th} power. However, the active surface of violet-responsive solar cell 311 has a shallower depth of 0.2 micrometers and an order of magnitude lower surface doping of 5*10E18 per cubic centimeter. This shallower depth and lower surface doping gives violet-responsive solar cell 311 a much higher spectral response in the green, blue, and violet range, photon energy greater than 2.1 electron volts, than typical solar cell 310.

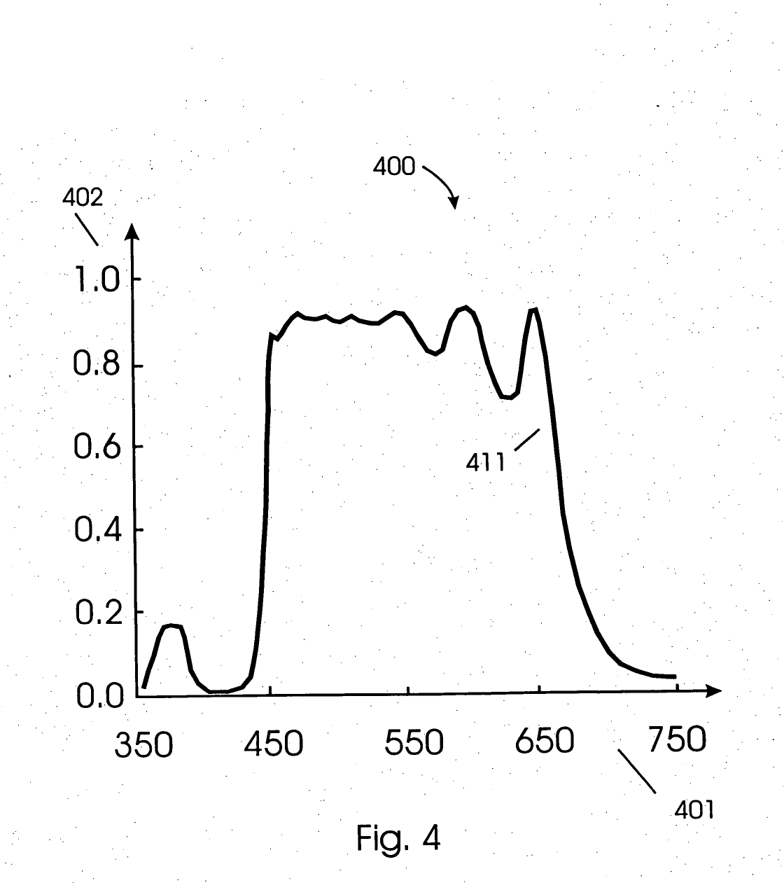

Violet-responsive solar cell 311 is well suited for use in double-pane window 100, if an optional dichronic coating is applied to exterior pane 101. A dicronic mirror reflects light of certain wavelengths and transmits light of other wavelengths, as depicted in FIG. 4. In FIG. 4, the transmission factor 402 of a particular dichronic mirror coating 411 is graphed versus wavelength 401. This dichronic mirror coating is available from Nikon, at microscopyu.com. In FIG. 4, the transmission factor 402 of 1.0 means 100%. The wavelength 401 is in nanometers. In FIG. 4, the reflectivity is equal to [1−transmissivity]. Thus, in FIG. 4, the dichronic mirror coating 411 reflects light shorter than 450 nanometers and longer than 680 nanometers. However, between. 450 and 650 nanometers, dichronic mirror coating 411 transmits approximately 90% of the incoming light.

Using the dichronic coating 411 on exterior pane 101 would tend to block damaging ultraviolet radiation while permitting visible light to pass through in order to impinge upon the active surfaces of solar cells 120 and 121, or for viewing by office occupants. Dichronic coating 411 is preferably on the inside surface of exterior pane 101, so that it is protected from outside elements, and occasional window cleaning. However, dichronic coating 411 could be on the outside surface of exterior pane 101. FIG. 4 shows that light of a wavelength longer than 450 nm, which represents an energy lower than 2.76 electron volts, is transmitted by diachronic coating 411. Violet-responsive solar cell 411 converts solar energy into DC electricity in this region less than 2.76 electron volts, per FIG. 3.

Table 1 shows the ranges of wavelengths of visible light, in nanometers, and the electron volt energy, thus allows the comparison of FIGS. 3 and 4. The electron volt energy is calculated by multiplying Planks constant, 4.136*10E-15 electron-volt-seconds by the speed of light 2.998*10E8 meters/second, and then dividing by the wavelength, as shown in the right-most column of Table 1.

TABLE 1
Wavelengths and Electron Volts of Visible Light

| Color | Range of Wavelength in nanometers | Range of Electron Volts |
|---|---|---|
| Violet | 400-424 nm | 3.1-2.92 |
| Blue | 424-491 mm | 2.92-2.53 |
| Green | 491-575 nm | 2.53-2.16 |
| Yellow | 575-585 nm | 2.16-2.12 |
| Orange | 585-647 nm | 2.12-1.92 |
| Red | 647-700 nm | 1.92-1.77 |

The dichronic coating in FIG. 4 is the commercially available Nikon V-1A filter, from microscopyu.com, which reflects wavelengths, of light shorter than 450 nm and transmits wavelengths of light from 450 nm to approximately 680 nm, which includes blue, green, yellow, orange, and red wavelengths. Infrared wavelengths greater than 700 nm are also reflected. Thus, the dichronic mirror coating in the Nikon V-1A filter transmits most of the visible light spectrum, while reflecting back out of the window the violet and short-wavelength-blue light.

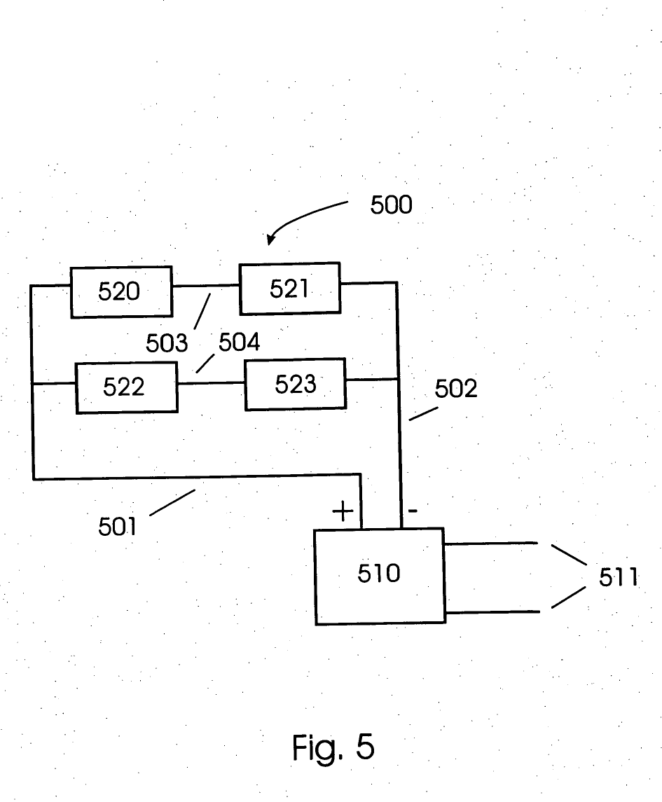

FIG. 5 shows an electrical assembly 500 for the conversion of direct current (DC) power from a plurality of solar cells 520, 521, 522, and 523 into alternating current (AC) power. Solar cells 520, 521, 522, and 523 generate DC current and voltage in double-pane window 100. Solar cells 520 and 521 are connected as a subgroup in series, by conductor 503, to increase DC voltage. Likewise, solar cells 522 and 523 are connected as a subgroup in series, by conductor 504, to increase DC voltage. It is preferred that all subgroups in double-pane window 100 have the same number of component solar cells, so that each subgroup has the same DC voltage rating.

The solar cell subgroups consisting-of solar cells 520 and 521, as well as 522 and 523 are connected in parallel via conductors 501 and 502, to increase the DC current. Conductors 501, 502, 503, and 504 are preferably wires made of copper, but could be made of other conductive materials, such as aluminum or gold.

AC converter 510 converts the DC current and voltage from solar cells for assembly 500, into AC current and voltage which would then be fed into the AC power grid of the building via conductors 511. The AC current and voltage output of DC-to-AC converter 511 would preferably vary at a frequency of 60 Hertz (60 times a second) in the United States and preferably vary at a frequency of 50 Hertz in Europe. If the AC current and voltage output of DC-to-AC converter 511 is being superimposed with purchased AC power from a utility, the phase of the AC current and voltage from DC-to-AC converter 511 will have to match the phase of the AC current and voltage from the utility. In this manner, the solar generated DC electricity from window 100 is converted to usable AC electricity while window 100 still provides interior illumination and a view of the outside world.

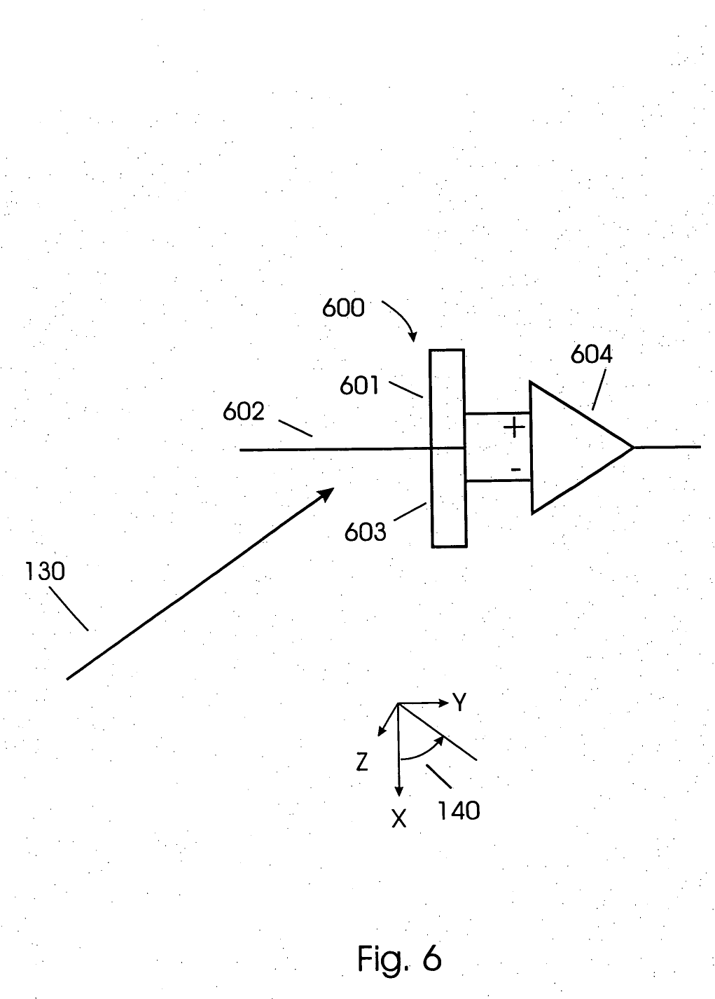

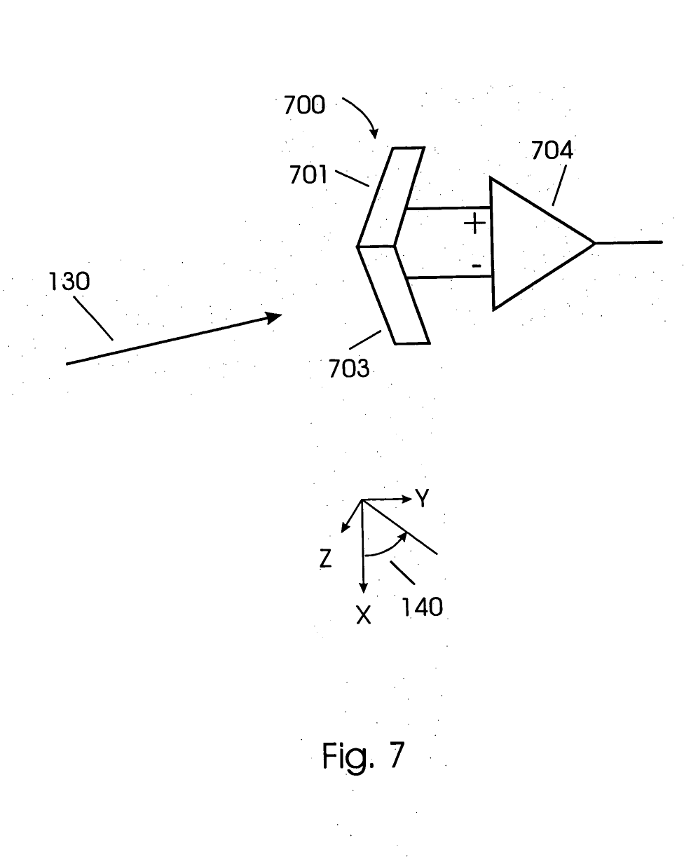

FIGS. 6 and 7 show detail of illumination sensor 230 of FIG. 2. In FIG. 6, illumination sensor 600 has two photocells 601 and 603. Both photocells 601 and 603 are oriented in parallel. In between photocells 601 and 603 is shade 602. The output of photocells 601 and 602 go to differential amplifier 604. If one of the photocells is shaded, meaning that the solar cells 120 and 121 of FIG. 2 are not pointed directly at the sun, the output of differential amplifier will indicate this to microprocessor 212. Then microprocessor 212 can correct the alignment of the solar cells relative to the sun.

Similarly, in FIG. 7, illumination sensor 700 has two photocells 701 and 703. Rather than being oriented in parallel as in FIG. 6, photocells 701 and 703 are oriented in at an angle to one another. The output of photocells 701 and 702 go to differential amplifier 704. If one of the photocells more perpendicular to the sun than the other, meaning that the solar cells 120 and 121 of FIG. 2 are not pointed directly at the sun, the output of differential amplifier will indicate this to microprocessor 212. Then microprocessor 212 can correct the alignment of the solar cells relative to the sun.

Flowchart 800 describes the motion control algorithm for double-pane window 100. This algorithm is stored in memory 213 and executed by microprocessor 212. Flowchart 800 begins at stem 802 and flows to step 804, where microprocessor 212 gets the sunup time, the sundown time, and the azimuth of double-pane window 100 from memory 213. The process then flows from step 804 to step 806, where microprocessor 212 gets the 24-hour time T from 24-hour clock 217. The process flows from step 806 to decision step 808, where the determination is made whether the 24-hour time T falls during daylight, i.e., between sunup and sundown. If the answer is no in decision step 808, the process flows to step 810, where ANGLE is set to 90 degrees. The process then flows from step 810 to step 818, where microprocessor 212 commands that motor 210 rotates solar cells 120 and 121 of FIGS. 1 and 2 in a generally counterclockwise direction until the angle of the solar cells ANGLE_140 is equal to the value of ANGLE determined in step 810. This places the solar cells in double-pane window 100 perpendicular to the panes of glass and allows external viewing. Alternately in step 810, ANGLE could be set to 0 degrees and viewing into the double-pane window is blocked for privacy reasons between sundown and sunup. Regardless of whether ANGLE is 90 degrees for viewing or 0 degrees for privacy in step 810, the activity in step 818 is called “parking” the solar cells.

If the answer is yes in decision step 808, the process flows to step 812, where ANGLE is calculated as ANGLE=Azimuth−15*T. This equation is derived from (eqn.1):
ANGLE=90−15 deg/hr*[T−6 hours+(180−Azimuth)/15] (eqn.1)
In (eqn.1), T is the 24-hour time and is obtained from 24-hour clock 217 in FIG. 2. 15 degrees/hour is the apparent angular motion of the sun. When double-pane window 100 is facing due South in FIG. 1, the Y axis is facing due North and the X axis is facing due East. Then, the azimuth of double-pane window 100 is 180 degrees. (Eqn.1) is designed so that the solar cells will face due East at 6.0 hours (6am), ANGLE_140=90 degrees; due South at 12.0 hours (noon), ANGLE_140=0 degrees; and due West at 18.0 hours (6pm), ANGLE_140=−90 degrees.

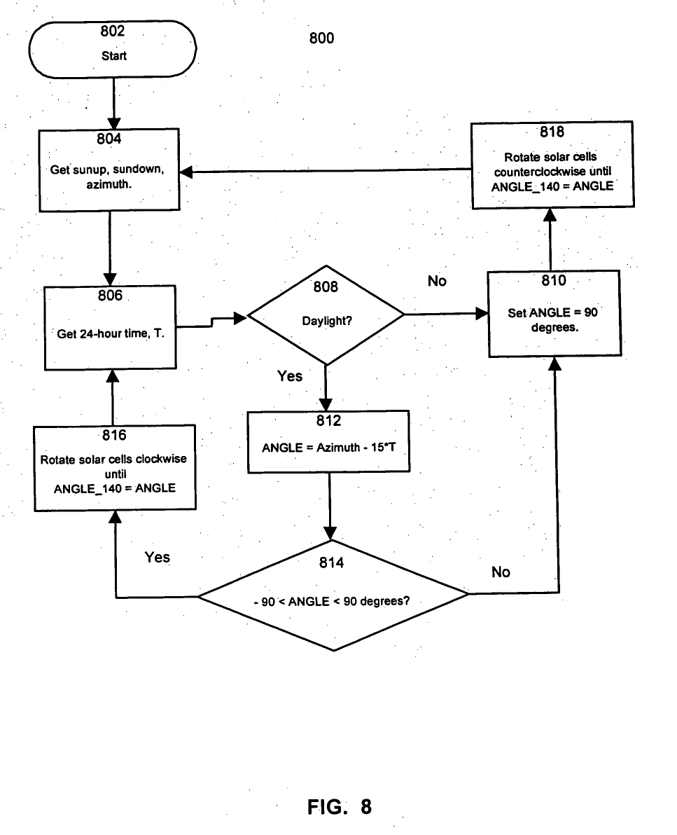

Via the actual azimuth of the window, the term (180−azimuth)/15 takes into account the time deviation of the double-pane window when it is not facing due South. Simplifying (eqn.1) results in (eqn.2), and it is (eqn.2) which is shown in step 812 of FIG. 8.
ANGLE=Azimuth−15*T (eqn.2)

The process then flows from step 812 to decision step 814, where a check is made whether −90 degrees<ANGLE<90 degrees. Step 814 is designed to keep the solar cells from seeking sunlight from behind the window and thus, from inside the building. If the result of decision step is no, then the process flows to step 810. However, if the result of decision step 814 is yes, the process flows to step 816, where microprocessor 212 commands that motor 210 rotate solar cells 120 and 121 of FIG. 1 in a generally clockwise direction until the angle of the solar cells ANGLE_140 is equal to the value of ANGLE calculated in step 812. The activity in step. 816 is called “tracking” the solar cells. Step 816 may include a pause time of five to fifteen minutes, as it is not necessary for microprocessor 212 to activate motor 210 to track the apparent motion of the sun.

In FIG. 8, and the explanation thereof, solar cells 120 and 121 are rotated alternately in a clockwise or a counterclockwise direction. Furthermore, solar cells 120 and 121 are never angled outside of the region −90 degrees≦ANGLE≦90 degrees. Thus, solar cells 120 and 121 never break their electrical wiring by twisting it multiple times in the same direction.

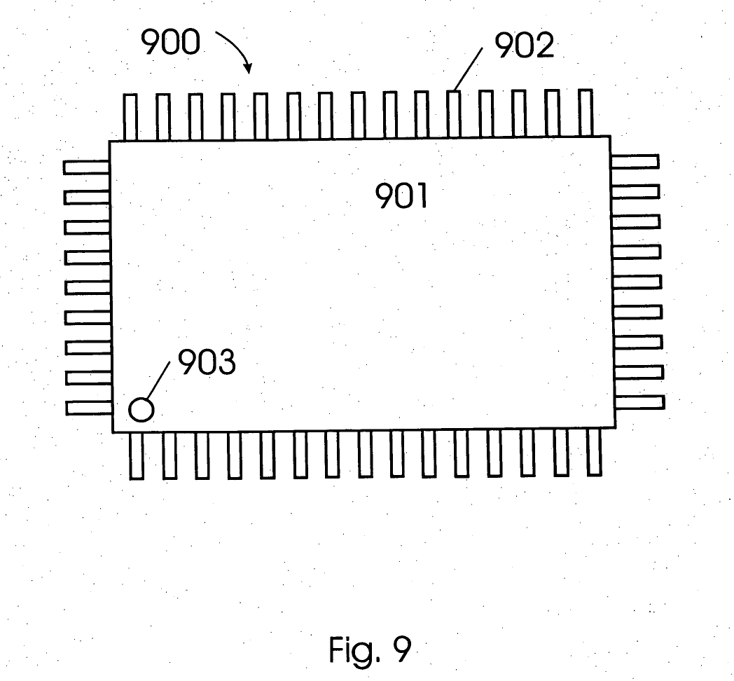

Memory 213 is preferably semiconductor chip 900, as shown in FIG. 9. Semiconductor chip 900 stores the algorithm in FIG. 8, as well as a table of sunup and sundown times for each day of the year, and the azimuth of the installed window 100. The exterior of chip 900 shows a typically square or rectangular body 901 with a plurality of electrical connectors 902 along the perimeter of body 901. There is typically an alignment dot 903 at one corner of chip 900 to assist with the proper alignment of chip. 900 on a printed circuit card. Within body 901, chip 900 consists of a number of interconnected electrical elements, such as transistors, resistors, and diodes. These interconnected electrical elements are fabricated on a single chip of silicon crystal, or other semiconductor material such as gallium arsenide (GaAs) or nitrided silicon, by use of photolithography. One complete layering-sequence in the photolithography process is to deposit a layer of material on the chip, coat it with photoresist, etch away the photoresist where the deposited material is not desired, remove the undesirable deposited material which is no longer protected by the photoresist, and then remove the photoresist where the deposited material is desired. By many such photolithography layering-sequences, very-large-scale integration (VLSI) can result in tens of thousands of electrical elements on a single chip. Ultra-large-scale integration (ULSI) can result in a hundred thousand electrical elements on a single chip.

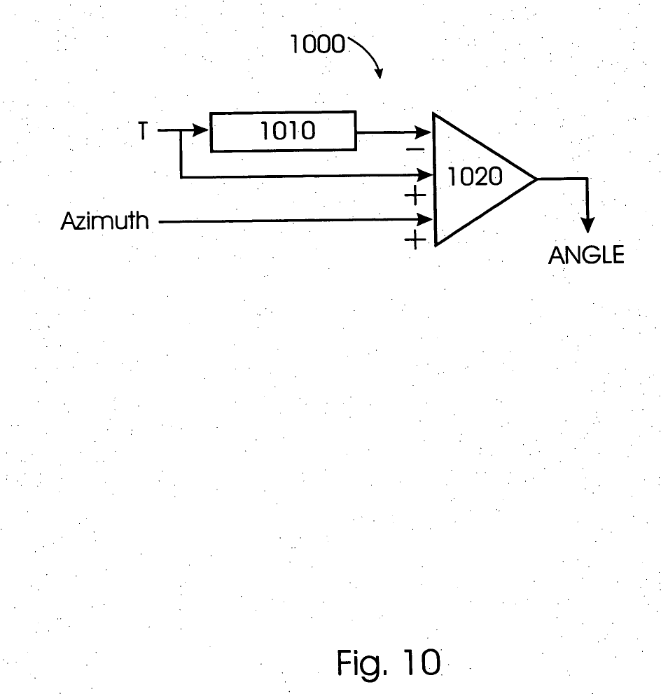

FIG. 10 shows binary arithmetic calculator 1000 for the simplified calculation of ANGLE in step 812 of FIG. 8. This simplification eliminates the need for digital multiplication by microprocessor 212, which may reduce the cost of microprocessor 212 and hence the double-pane window 100. (Eqn.2) is rewritten as (eqn.3), where −15*T is now calculated as T−16*T. The azimuth, which double-pane window 100 is facing, is stored in memory 213 in binary form. Binary form is equally known as base-2. For example, an azimuth of 135 degrees, representing double-pane window 100 facing the south-east, is 207 in base-8 and 10000111 in base-2. Since the azimuth of an installed window typically does not change, the binary value of azimuth typically needs to be calculated only once, when double-pane window 100 is first installed. Time T generated by clock 217 as a binary number. Then, in register 1010 of microprocessor 212, time T is bit-shifted by the left by four bits, which is the same as multiplying time T by 1000[base-2], which is equal to 16[base-10]. Finally, accumulator 1020 adds azimuth, then adds time T, then subtracts 16*T from the output of register 1010, to yield (eqn.3). (Eqn.3) is identical to (eqn.2); however, (eqn.3) does :not require digital multiplication. (Eqn.3) only requires a simple bit-shift by four bits to the left, addition, and subtraction, to calculate ANGLE in step 812 of FIG. 8.
ANGLE=Azimuth+T−16*T (eqn.3)

In FIG. 1, the Z axis is preferably pointing in the vertically-upwards direction. This is especially desired for a south-facing double-pane window 100. However, for an east-facing or a west-facing double-pane window 100, the alternate embodiment of having the X axis parallel to the vertical direction may be desirable. For an east-facing window, the X axis would-be pointing in the vertically downwards direction. For a west-facing window, the X axis would be pointing in the vertically upwards direction. FIG. 8 would not need to be altered. The azimuth of the east-facing window is 90 degrees, and FIG. 8 calculates ANGLE in step 812 as 0 degrees at 6 am, or T=6.00 hours, meaning that the solar cells are parallel to the east-facing panes of glass at that time, as generally desired. Similarly, the azimuth of the west-facing window is 270 degrees, and FIG. 8 calculates ANGLE in step 812 as 0 degrees at 6 pm, or T=18.00 hours, meaning that the solar cells are parallel to the west-facing panes of glass at that time, as generally desired. This alternate embodiment would:be of increasing value for double-pane windows 100 installed near the equator of the Earth. For both the east and west-facing double-pane windows 100 in this alternate embodiment, the Z axis of FIGS. 1 and 2 would point generally in the northern direction so that the solar cells track in the clockwise direction to follow the apparent motion of the sun.

While the invention has been shown and described with reference to a particular embodiment thereof, it will be understood to those skilled in the art, that various changes in form and details may be made therein without departing from the spirit and scope of the invention. For example, double-pane window 100 is described in the traditional sense as being in a vertical plane, which means to be along the side of a building. However, double-pane window 100 could equally be installed at an angle to the vertical, such as in a skylight.

1. A double-pane window for the generation of electricity from light during daylight hours, comprising:
a first and second panes, said panes are parallel to each other, each of said panes having a perimeter; and
a plurality of solar cells pivotally mounted between said first and second panes, said plurality of solar cells pivot to follow a movement of a sun.

2. The double-pane window of claim 1, further comprising a dichronic coating applied to one of said panes.

3. The double-pane window of claim 1, wherein said plurality of solar cells are coupled to a controller, said controller directs said plurality of solar cells to follow said movement of said sun.

4. The double-pane window of claim 1, wherein said plurality of solar cells are parallel to each other.

5. The double-pane window of claim 1, wherein said controller includes a memory, said memory containing a set of solar information.
